(19) United States
(12) Patent Application Publication
(10) Pub. No.: US 2026/0073057 A1
(43) Pub. Date: Mar. 12, 2026

(54) ANALYSIS SYSTEM, METHOD, AND PROGRAM

(71) Applicant: NEC Corporation, Tokyo (JP)

(72) Inventors: Shunichi KINOSHITA, Tokyo (JP); Masaki INOKUCHI, Tokyo (JP); Yoshinobu OHTA, Tokyo (JP)

(73) Assignee: NEC Corporation, Tokyo (JP)

(21) Appl. No.: 19/386,359

(22) Filed: Nov. 12, 2025

Related U.S. Application Data
(63) Continuation of application No. 17/794,366, filed on Jul. 21, 2022, now abandoned.

(51) Int. Cl. G06F 21/57; G06F 21/54; G06F 21/55

(52) U.S. Cl. CPC G06F 21/577; G06F 21/54; G06F 21/554

(57) ABSTRACT

An analysis system includes: an unconfirmed fact generation unit which generates facts that indicate unknown information of a system to be diagnosed or a device among facts that indicate a state related to security in the system to be diagnosed or the device included in the system to be diagnosed, as unconfirmed facts.

### DESCRIPTION

This application is a continuation application of United States Patent Application Ser. No. 17/794,366 filed on July 21, 2022, which is a National Stage Entry of PCT/JP2020/004311 filed on February 5, 2020, the contents of all of which are incorporated herein by reference, in their entirety.

### Technical Field

The present invention relates to an analysis system, an analysis method, and an analysis program for analyzing information that serves as a basis for making decisions concerning actions against attacks on a system to be diagnosed.

### Background Art

Information processing systems that include such as multiple computers are required to take security measures to protect information assets from cyber attacks, and the like. The security measures include diagnosing such as the vulnerability of the target system and removing the vulnerability if necessary, and the like.

A system that is the target of a security diagnose is referred to as a system to be diagnosed. A system that collects data such as the system configuration of the system to be diagnosed, identifies the vulnerabilities included in the devices in the system, and gives instructions for countermeasures is referred to as a security diagnosis system. Examples of security diagnosis systems are described in Patent Literatures (PTLs) 1-2.

PTL 1 describes a security management system that can perform integrated security management such as risk analysis, formulation of security measures and security policies, and security monitoring practices based on vulnerability information collected from devices to be inspected.

In addition, PTL 2 describes a diagnostic device that can reduce the load of vulnerability diagnosis on information processing device.

### Citation List

### Patent Literature

PTL 1: Japanese Patent Application Laid-Open No. 2005-242754 PTL 2: Japanese Patent Application Laid-Open No. 2017-68691

### SUMMARY OF INVENTION

### Technical Problem

It is difficult for a security diagnosis system to identify all the vulnerabilities included in the system configuration of a system to be diagnosed and in the devices in the system to be diagnosed. The reason for this is that scan of a system to be diagnosed performed to identify vulnerabilities is a heavy load for the system to be diagnosed, and is not a frequently performed process.

Another reason is that operational constraints limit the period during which scans can be performed on a system to be diagnosed, resulting in unscanned devices among the devices in the system to be diagnosed. As a result, the security diagnosis system may not be able to analyze the possibility of attacks on the system to be diagnosed.

Therefore, it is an object of the present invention to provide an analysis system, an analysis method, and an analysis program capable of analyzing a possibility of an attack in a system to be diagnosed even when it is not possible to collect sufficient information from each device in the system to be diagnosed.

### Solution to Problem

An analysis system according to the present invention is an analysis system includes an unconfirmed fact generation unit which generates facts that indicate unknown information of a system to be diagnosed or a device among facts that indicate a state related to security in the system to be diagnosed or the device included in the system to be diagnosed, as unconfirmed facts.

An analysis method according to the present invention is an analysis method includes generating facts that indicate unknown information of a system to be diagnosed or a device among facts that indicate a state related to security in the system to be diagnosed or the device included in the system to be diagnosed, as unconfirmed facts.

An analysis program according to the present invention, causing a computer to execute an unconfirmed fact generation process of generating facts that indicate unknown information of a system to be diagnosed or a device among facts that indicate a state related to security in the system to be diagnosed or the device included in the system to be diagnosed, as unconfirmed facts.

### Advantageous Effects of Invention

According to the present invention, it is possible to analyze a possibility of an attack in a system to be diagnosed even when it is not possible to collect sufficient information from each device in the system to be diagnosed.

### BRIEF DESCRIPTION OF DRAWINGS

FIG. 1 is a block diagram showing an example of the configuration of an analysis system of the first example embodiment of the present invention.

FIG. 2 is an explanatory diagram showing an example of an initial fact generated by a confirmed fact generation unit 103.

FIG. 3 is an explanatory diagram showing an example of an attack graph generated by an analysis unit 107.

FIG. 4 is an explanatory diagram showing another example of an attack graph generated by an analysis unit 107.

FIG. 5 is an explanatory diagram showing an example of a score indicating a probability that the state indicated by an unconfirmed fact is true.

FIG. 6 is an explanatory diagram showing another example of a score indicating a probability that the state indicated by an unconfirmed fact is true.

FIG. 7 is a flowchart showing the operation of the attack graph generation processing by the analysis system 100 of the first example embodiment.

FIG. 8 is a flowchart showing the operation of the additional scan execution processing by the analysis system 100 of the first example embodiment.

FIG. 9 is a block diagram showing another example of the configuration of the analysis system of the first example embodiment of the present invention.

FIG. 10 is an explanatory diagram showing an example of a hardware configuration of the analysis system according to the present invention.

FIG. 11 is a block diagram showing an overview of an analysis system according to the present invention.

### DESCRIPTION OF EMBODIMENTS

Hereinafter, example embodiments of the present invention are described with reference to the drawings.

### Example Embodiment 1

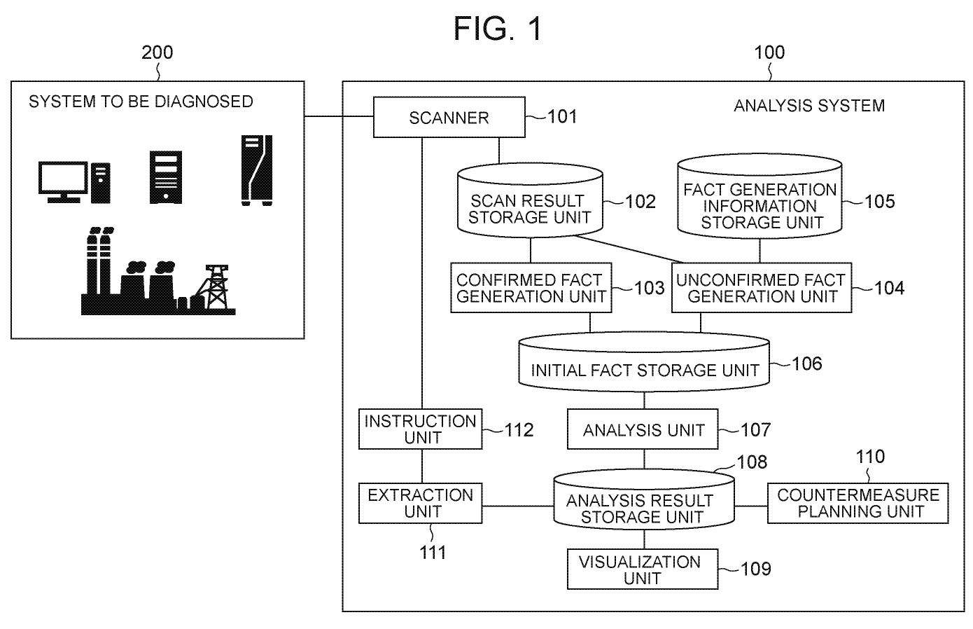

FIG. 1 is a block diagram showing an example of the configuration of an analysis system of the first example embodiment of the present invention. The analysis system 100 of the first example embodiment includes a scanner 101, a scan result storage unit 102, a confirmed fact generation unit 103, an unconfirmed fact generation unit 104, a fact generation information storage unit 105, an initial fact storage unit 106, an analysis unit 107, an analysis result storage unit 108, a visualization unit 109, a countermeasure planning unit 110, an extraction unit 111, and an instruction unit 112.

As shown in FIG. 1, the analysis system 100 is communicatively connected to a system to be diagnosed 200.

The analysis system 100 in this example embodiment is a system for analyzing a situation relating to security of a system to be diagnosed 200. The system to be diagnosed 200 is a system subject to security diagnosis by the analysis system 100.

In the following example embodiment, it is assumed that the system to be diagnosed 200 is mainly an IT (Information Technology) system in a company. In other words, in the system to be diagnosed 200, a plurality of devices are connected through a communication network. The system to be diagnosed 200 is not limited to the above example; for example, it may be a system for controlling an OT (Operational Technology) system.

The devices included in the system to be diagnosed 200 include a personal computer, a server, a switch, a router, and the like. However, the devices included in the system to be diagnosed 200 are not limited to these examples. The system to be diagnosed 200 also includes other type of device connected to a communication network. The device included in the system to be diagnosed 200 may be a physical device or a virtual device.

The number of devices included in the system to be diagnosed 200 is not limited to the example shown in FIG. 1. The number of devices included in the system to be diagnosed 200 is not particularly limited. Also, the analysis system 100 may be one of the devices included in the system to be diagnosed 200. The analysis system 100 may be set outside the system to be diagnosed 200 in a format such as cloud computing, and may be connected to the system to be diagnosed 200 through a communication network.

The scanner 101 has a function of collecting configuration information of the device included in the system to be diagnosed 200 by scanning the inside of the system to be diagnosed 200. The analysis system 100 may use a dedicated scanner existing outside the analysis system 100 instead of the scanner 101.

The scanner 101, as an example, collects each configuration information of the device at a predetermined timing. The predetermined timing includes a predetermined time every day, at startup of the devices, and the like. The predetermined timing may include other timings.

The timing and interval at which the scanner 101 collects each configuration information may be determined as appropriate according to the scale of the system to be diagnosed 200 and the specific function of the device, and the like. In addition, the scanner 101 may collect each configuration information of the device at other timings other than the timings so determined.

The configuration information collected by the scanner 101 may include the vulnerabilities included in the device, the operating system (OS) installed in the device and the version of the OS, the configuration information of the hardware installed in the device, the software installed in the device, the version of the software, and the software settings, etc.

The configuration information collected by the scanner 101 may include user accounts and account privileges, connected networks and IP (Internet Protocol) addresses, devices connected to the device communicably, communication destination devices communicating with the device, and the content of the communication, and CPU (Central Processing Unit) model.

Further, the configuration information collected by the scanner 101 may include communication data to be exchanged with the communication destination devices of the device, information on a communication protocol used for exchanging such communication data, and information indicating a status of ports of the device (which port is open), or data flow information.

The communication data includes, for example, information on the transmission source and the transmission destination of the communication data. In addition, the data flow information is information that indicates what kind of data is being transferred from which device to which device. In addition to information corresponding to communication data, the data flow information also includes information about data transferred via removable media, etc.

The examples of configuration information collected by the scanner 101 are not limited to the above examples. The scanner 101 may also collect, as the configuration information of the device, other information that is necessary for analyzing attacks that can be executed on the system to be diagnosed 200.

The scanner 101 stores the collected configuration information as scan results in the scan result storage unit 102. The scan result storage unit 102 has a function of storing the configuration information.

The configuration information stored by the scan result storage unit 102 is not limited to the information input from the scanner 101. For example, the scan result storage unit 102 may store in advance information of a device not shown in the figure.

The confirmed fact generation unit 103 has a function of generating one or more initial facts by referring to the configuration information stored in the scan result storage unit 102.

In the present example embodiment, a fact is a state in a system to be diagnosed 200 or a device included in the system to be diagnosed 200, which is described in a format that can be referred to by the analysis unit 107 described below. The fact mainly indicates a state related to security in the system to be diagnosed 200 or the device included in the system to be diagnosed 200.

An initial fact is a general term for the fact generated by the confirmed fact generation unit 103 and the fact generated by the unconfirmed fact generation unit 104 described below.

In other words, the confirmed fact generation unit 103 generates an initial fact in the system to be diagnosed 200 based on the configuration information collected. Hereafter, facts generated from the configuration information obtained from the scan are also referred to as confirmed facts. The confirmed fact generation unit 103 generates the facts indicated by the configuration information as confirmed facts.

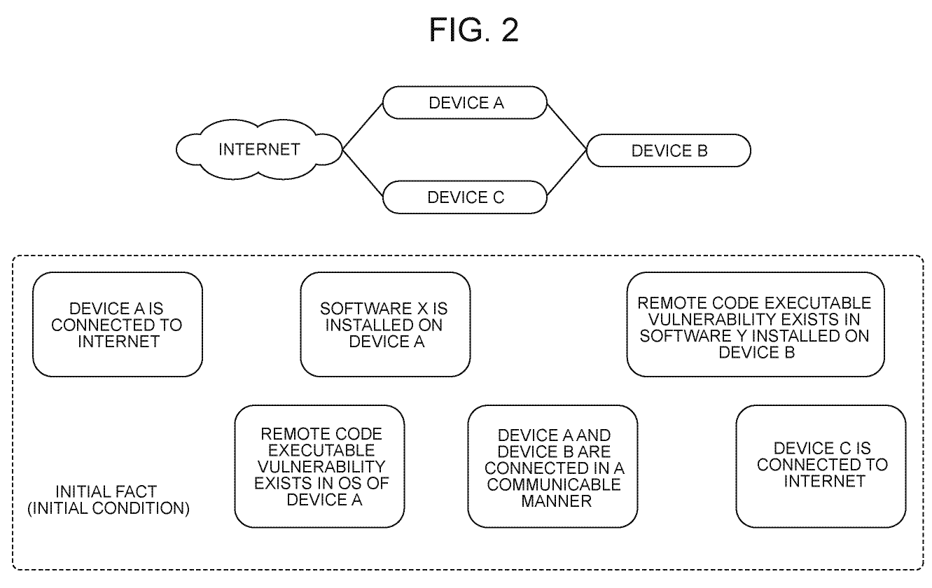

FIG. 2 is an explanatory diagram showing an example of an initial fact generated by a confirmed fact generation unit 103. The upper of FIG. 2 shows the system to be diagnosed 200 assumed in this example.

As shown in the upper of FIG. 2, it is assumed that the system to be diagnosed 200 in this example includes a device A, a device B, and a device C. The device A and the device C are connected to the Internet. In addition, the device B is connected to the device A and the device C through a network.

The scanner 101 collects configuration information for each of the device A, B, and C from each device. Next, the scanner 101 stores each of the collected configuration information in the scan result storage unit 102. The confirmed fact generation unit 103 generates an initial fact using the configuration information about each device stored in the scan result storage unit 102.

The confirmed fact generation unit 103, for example, references the OS and OS version installed in a certain device from the configuration information and generates an initial fact representing the situation that the OS of the referenced version is installed in the target device.

Similarly, the confirmed fact generation unit 103 may reference certain software and software version installed on a certain device from the configuration information and generate an initial fact representing the situation that the software of the referenced version is installed in the target device.

Alternatively, the confirmed fact generation unit 103 may generate an initial fact representing the situation that the first device and the second device are communicatively connected by referring to the second device that is communicatively connected to a certain first device from the configuration information.

The initial fact generated by the confirmed fact generation unit 103 is not limited to the above example. The confirmed fact generation unit 103 may generate any information included in the configuration information as the initial fact.

The lower of FIG. 2 shows an example of an initial fact generated by the confirmed fact generation unit 103 with respect to the system to be diagnosed 200 described above. In the example shown in the lower of FIG. 2, each of the elements represented by the rounded corner rectangle represents one initial fact.

As shown in the lower of FIG. 2, the confirmed fact generation unit 103 generates "The device A is connected to the Internet", "The software X is installed on the device A", and the like as initial facts. The initial facts to be generated are not limited to the example shown in the lower of FIG. 2, and may be generated as appropriate according to the system to be diagnosed 200 or each device.

The confirmed fact generation unit 103 stores the generated one or more initial facts in the initial fact storage unit 106. The initial fact storage unit 106 has a function of storing the initial facts.

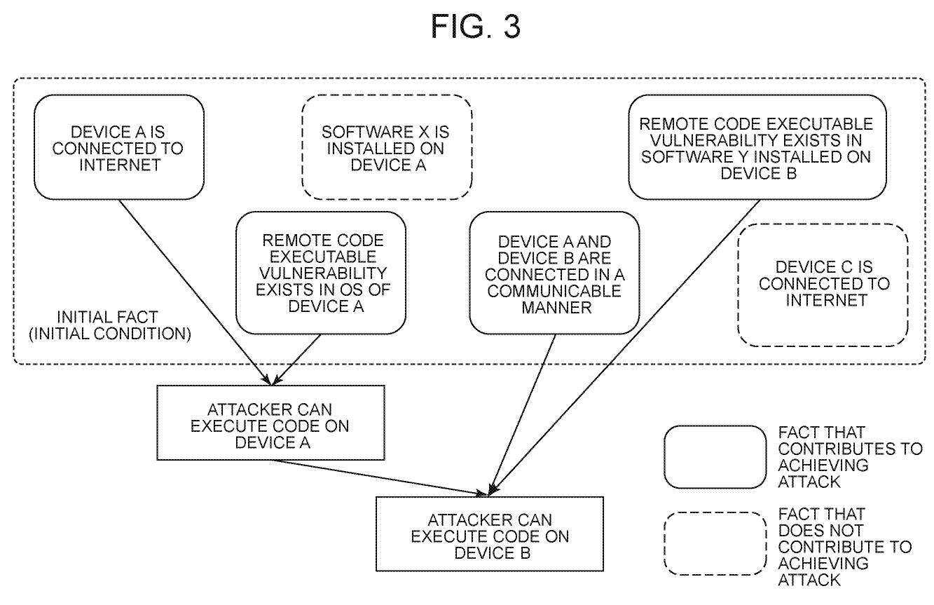

The analysis unit 107 has a function of generating an attack graph based on one or more initial facts stored. FIG. 3 is an explanatory diagram showing an example of an attack graph generated by the analysis unit 107.

The attack graph in this example embodiment is a graph that can represent a flow of an attack that can be executed in the system to be diagnosed 200. In other words, the attack graph can represent the state such as the presence or absence of vulnerabilities of a certain device, and the relation from attacks that can be executed on a certain device to attacks that can be executed on the device or other device in the system to be diagnosed 200.

The attack graph is represented as a directed graph in which facts are nodes and the relations between facts are edges. In the attack graph represented as a directed graph, the facts are either the initial facts described above or facts representing attacks that can be executed in each device included in the system to be diagnosed 200. By generating the attack graph by the analysis unit 107, attacks that may occur in the system to be diagnosed 200 can be analyzed.

When the generated attack graph is used, the attack path representing the series of flow from the initial fact to the fact representing the possibility of an attack can be derived. In other words, the analysis unit 107 can derive attacks that can be executed in the system to be diagnosed 200.

Then, when the attack path is used, it is possible to analyze security events that are difficult to determine by simply scanning individual devices for obtaining vulnerability information, and the like, such as the flow of the attack in the system to be diagnosed 200, devices that require priority countermeasures.

The analysis unit 107, as an example, generates an attack graph using an analysis rule based on one or more initial facts. An analysis rule is a rule for deriving another fact from one or more facts. The analysis rules are predetermined in the analysis system 100.

The analysis unit 107 determines whether the state related to security represented by the initial fact matches the conditions indicated by the analysis rules. If the initial fact matches all the conditions indicated by the analysis rules, the analysis unit 107 derives a new fact. The new fact represents, for example, a content of an attack that can be executed by each device included in the system to be diagnosed 200.

The derivation of a new fact indicating that an attack is possible indicates that the attack represented by the derived new fact is executable when the device included in the system to be diagnosed 200 is in the state represented by the initial fact used to derive the new fact. In other words, the fact used to derive the new fact is a precondition for the attack represented by the new fact to become executable.

In addition, another attack may become executable due to the fact that a certain attack is executable. In that case, the analysis unit 107 repeatedly performs the derivation of new facts using the analysis rules with the newly derived facts as preconditions as described above in addition to the initial facts.

The derivation of new facts is performed repeatedly, for example, until no new facts are derived. With the derivation of the new fact, the analysis unit 107 generates an attack graph by using the initial fact or the new fact as a node and connecting the fact including the initial fact, which is a premise of the new fact, to the new fact with an edge.

The analysis unit 107 classifies the initial facts into facts that contribute to the execution of the attack and facts that do not contribute to the execution of the attack. The facts that contribute to the execution of the attack are the facts used to generate the attack graph among the initial facts. The facts that do not contribute to the execution of the attack are the facts not used to generate the attack graph among the initial facts.

Hereinafter, a generation example of an attack graph by the analysis unit 107 is described with reference to FIG. 3, specifically. In the system to be diagnosed 200, it is assumed that the initial facts shown in FIG. 3 have been generated.

Also assume that the following relation is predetermined as an analysis rule: "An attacker can execute code on a device connected to the Internet" when "A certain device is connected to the Internet" and "A remote code executable vulnerability exists in the OS of the device connected to the Internet".

Referring to FIG. 3, it can be seen from the initial facts that all of the conditions of the above analysis rules are satisfied with respect to the device A. Therefore, the analysis unit 107 derives a new fact that "An attacker can execute code on the device A".

The analysis unit 107 also generates an attack graph that represents an attack path from the initial facts to the derived new fact. Specifically, the analysis unit 107 connects each of the two initial facts to the fact representing the attack with an edge that goes from each of the two initial facts to the fact representing the executable attack.

Next, a generation example of an attack graph by the analysis unit 107 in the case where an attack becomes executable and therefore another attack becomes executable is described.

In the example shown in FIG. 3, it is assumed that the initial fact and the fact that "An attacker can execute code on the device A" are generated. Also assume that the following relation is predetermined as an analysis rule: "An attacker can execute code on the first device" when "A remote code executable vulnerability exists in the software Y installed on the certain first device" and "The first device and the second device are connected in a communicable manner" and "An attacker can execute code on the second device".

Referring to FIG. 3, it can be seen from the initial facts that "A remote code executable vulnerability exists in the software Y installed on the device B" and "The device A and the device B are connected in a communicable manner" in the system to be diagnosed 200. In addition, as mentioned above, it is derived that "An attacker can execute code on the device A". In other words, it can be seen that all the conditions included in the analysis rules are satisfied. In other words, it can be seen that "An attacker can execute code on the device B".

Therefore, the analysis unit 107 derives a new fact that "An attacker can execute code on the device B". The analysis unit 107 also generates an attack graph that represents an attack path from the initial facts to the derived new fact.

Specifically, the analysis unit 107 connects each of the three facts to the fact representing the attack with an edge that goes from each of the two initial facts and the fact "An attacker can execute code on the device A" to the fact representing the executable attack.

The attack graph shown in FIG. 3 is generated by the above process. In other words, the attack path represents the series of flow from the initial facts to "An attacker can execute code on the device B".

Next, the analysis unit 107 classifies the initial facts into facts that contribute to the execution of the attack and facts that do not contribute to the execution of the attack. Referring to FIG. 3, among the initial facts, "The device A is connected to the Internet", "A remote code executable vulnerability exists in the OS of the device A", "The device A and the device B are connected in a communicable manner", and "A remote code executable vulnerability exists in the software Y installed on the device B" are used to generate an attack graph.

Therefore, the analysis unit 107 classifies "The device A is connected to the Internet", "A remote code executable vulnerability exists in the OS of the device A", "The device A and the device B are connected in a communicable manner", and "A remote code executable vulnerability exists in the software Y installed on the device B" as facts that contribute to the execution of the attack.

Similarly, referring to FIG. 3, among the initial facts, "The software X is installed on the device A" and "The device C is connected to the Internet" are not used to generate an attack graph. Therefore, the analysis unit 107 classifies "The software X is installed on the device A" and "The device C is connected to the Internet" as facts that do not contribute to the execution of the attack.

The procedure for the analysis unit 107 to generate the attack graph is not limited to the procedure described above. The analysis unit 107 may generate the attack graph based on the initial facts according to a procedure other than the procedure described above. The analysis unit 107 may analyze using another method other than those described above for requiring an attack or a flow of an attack that can be executed in the system to be diagnosed 200 from the initial facts.

It is assumed that, depending on the system to be diagnosed 200, the analysis unit 107 may not be able to generate an attack graph that includes attack paths. For example, if sufficient security measures are implemented for each device of the system to be diagnosed 200, and no initial facts are generated that represents the premise that an attack can be executed, it is assumed that no attack graphs that include meaningful attack paths are generated.

Following the above procedure, the analysis unit 107 generates an attack graph. The analysis unit 107 stores information indicating the generated attack graph in the analysis result storage unit 108. The analysis result storage unit 108 has a function of storing the information indicating the attack graph.

Hereinafter, the features of this example embodiment that solve the above problem will be described. As described above, among the configuration information of the system to be diagnosed 200, the configuration information that the scanner 101 can collect is limited. One of the reasons is that it is difficult for the scanner 101 to perform an active scan such as transmitting arbitrary data because the system to be diagnosed 200 is heavily loaded.

For example, a PLC (Programmable Logic Controller) used to control the opening and closing of valves in a factory, etc., even a slight load may cause a malfunction. Therefore, the scanner 101 cannot perform a port scan which sends packets to the PLC and analyzes the response contents.

Even for devices that can be scanned, for example, for simple scans where the load is minor, the execution of scans to acquire detailed information may not be acceptable to the user of the device because of the heavy load. If not allowed by the user, the scanner 101 cannot scan the device in detail.

Another reason is that when the configuration information is collected by passive scanning, where the scanner 101 receives business traffic, etc., flowing over the communication network, during the period in which the collection takes place, not all of the business traffic flows. For example, it is highly likely that the scanner 101 will not be able to collect business traffic indicating the contents of fault handling or monthly updates, etc., during a predetermined period.

Another reason is that the scanner 101 cannot collect sufficient information when the available scanner products or scanning methods are limited due to operational constraints or other reasons. For example, due to contractual reasons, an administrator may only be able to use a specific type of scanner as the scanner 101.

Another reason is that the scanner 101 cannot detect an unknown vulnerability or a vulnerability for which a modification program has not yet been provided. As described above, when the collected configuration information is limited, it may not be possible to obtain a comprehensive attack path.

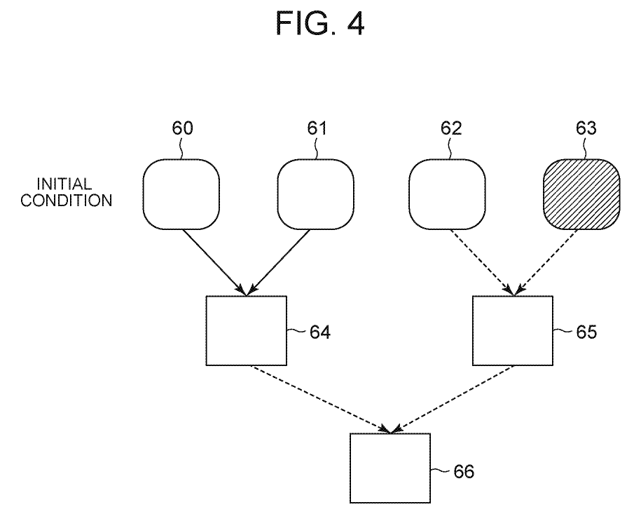

FIG. 4 is an explanatory diagram showing another example of an attack graph generated by the analysis unit 107. The initial facts 60-62 shown in FIG. 4 are the confirmed facts generated by the confirmed fact generation unit 103. The initial fact 63 is a fact that does not indicate the configuration information obtained by scanning and was not generated by the confirmed fact generation unit 103, but indicates the state of the device included in the system to be diagnosed 200.

If the initial fact 63 is not generated, the analysis unit 107 cannot derive the attack path of the attack that can be executed from the initial fact 62 and the initial fact 63 to the attack 65. Also, the analysis unit 107 cannot derive the attack path of the attack that can be executed from the fact 64 and the fact 65 to the attack 66. The dashed arrows shown in FIG. 4 mean that the attack paths including the arrows cannot be derived.

The unconfirmed fact generation unit 104 of this example embodiment has a function of generating a fact (hereinafter, referred to as an unconfirmed fact) indicating unknown information of the system to be diagnosed 200 or the device included in the system to be diagnosed 200. The unconfirmed fact is, for example, a fact that is difficult to generate from the configuration information obtained from a scan by the scanner 101.

The fact in the shaded pattern shown in FIG. 4 mean that it is an unconfirmed fact. The analysis unit 107 also classifies unconfirmed facts into facts that contribute to the execution of the attack and facts that do not contribute to the execution of the attack.

As a first method of generating unconfirmed facts, the unconfirmed fact generation unit 104 generates, for example, generally assumed conditions as unconfirmed facts. For example, with respect to software that is installed by default, the unconfirmed fact generation unit 104 generates an unconfirmed fact that the software is installed.

As a specific example, the unconfirmed fact generation unit 104 generates an unconfirmed fact that the .NET Framework (registered trademark) is installed for a PC whose OS is Windows (registered trademark).

The unconfirmed fact generation unit 104 also generates unconfirmed facts corresponding to default settings and settings that are not default settings but are often used.

In addition, the unconfirmed fact generation unit 104 searches an external database for a host, OS, or software having a configuration similar to the configuration of the device included in the system to be diagnosed 200, and generates unconfirmed facts corresponding to the information about the searched host etc.

The fact generation information storage unit 105 has a function of storing fact generation information. The fact generation information is information that indicates the generally assumed state described above. Specifically, the fact generation information indicates software installed by default, contents of default settings, general configuration of the host, etc.

The unconfirmed fact generation unit 104 generates unconfirmed facts by referring to the fact generation information stored in the fact generation information storage unit 105. The fact generation information storage unit 105 may exist in external to the analysis system 100.

The unconfirmed fact generation unit 104 may compute the probability that the state indicated by the generated unconfirmed fact is true as a score, and determine whether or not to include the unconfirmed fact in one or more initial facts using the computed score.

For example, the unconfirmed fact generation unit 104 may include unconfirmed facts having a score above a threshold value in one or more initial facts. Also, the unconfirmed fact generation unit 104 may include N (N is an integer greater than or equal to 1) unconfirmed facts having the highest scores from the first to the Nth in the one or more initial facts using the value N separately given by the administrator or the like.

The analysis unit 107 may treat the computed score as the probability that the state indicated by the fact is true, and may compute the feasibility of the attack by using the score when analyzing the attack path.

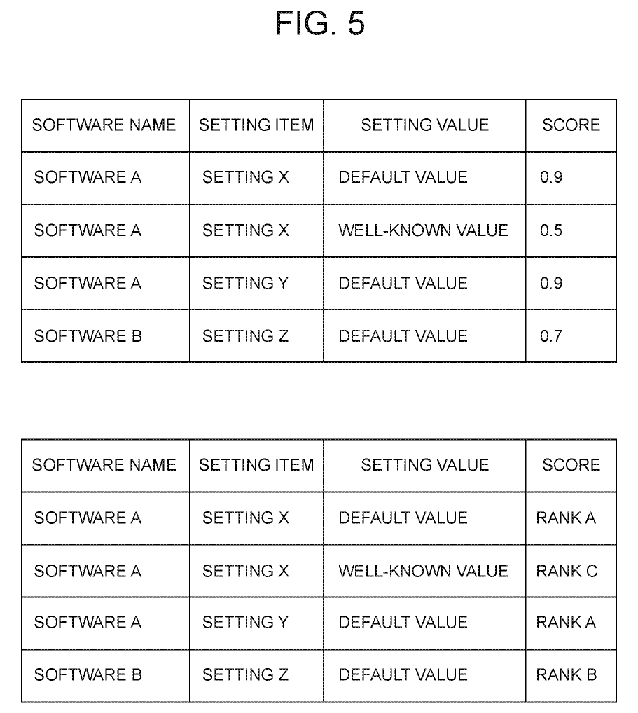

The score indicating the probability that the state indicated by an unconfirmed fact is true may be preset by the administrator. FIG. 5 is an explanatory diagram showing an example of a score indicating a probability that the state indicated by an unconfirmed fact is true.

As shown in the upper of FIG. 5, the administrator defines in advance the possibility that a default value or a well-known value is set for each setting item of each software as a score. For example, the possibility that a default value is set for setting X in software A is "0.9".

As shown in the lower of FIG. 5, the administrator may also set a score indicating the probability that the state indicated by the unconfirmed fact is true as a rank instead of a value. In the example shown in the lower of FIG. 5, the ranks are set as higher scores in the order of Rank A, Rank B, and Rank C.

As a second method of generating unconfirmed facts, the unconfirmed fact generation unit 104 generates unconfirmed facts by estimating environment information not included in the scan results based on the scan results. In other words, the unconfirmed fact generation unit 104 generates unconfirmed facts based on the configuration information of the device.

For example, the unconfirmed fact generation unit 104 may generate an unconfirmed fact that a data flow exists between hosts from a scan result regarding a free port of each host and reachability between each host. As a data flow, for example, file sharing can be considered.

The scan result for reachability indicates whether or not communication is possible from each host to each other host. Furthermore, the scan result for reachability may include information such as the source and destination ports where communication is possible. The scan result for reachability specifically indicate network configuration, network firewall rules, host firewall rules, etc.

The unconfirmed fact generation unit 104 may also generate unconfirmed facts based on the similarity of the components included in the system to be diagnosed 200, or the association of the components. The components include a host, an OS, software, and the like.

For example, if the last update date of the OS and software installed on one host is obtained, then the unconfirmed fact generation unit 104 may generate an unconfirmed fact that the same date is the last update date for the OS and software installed on the host or another host.

Also, if the scan result of Host A is obtained but the scan result of Host B is not obtained regarding Host A and Host B which have similar configurations and functions, the unconfirmed fact generation unit 104 may generate unconfirmed facts related to Host B based on the contents of the scan result of Host A. Host A and Host B are two hosts subject to load balancing, for example.

In addition, if the same file, such as a PDF (Portable Document Format) file, exists on two hosts for which no data flow has been observed, the unconfirmed fact generation unit 104 may generate an unconfirmed fact indicating the data flow of file sharing between hosts. The reason for this is that file sharing may have taken place.

However, if the same file is a file in the system directory, the unconfirmed fact generation unit 104 does not have to generate an unconfirmed fact. The reason for this is that files in the system directory are files originally provided by the system, and it is unlikely that file sharing has taken place.

The unconfirmed fact generation unit 104 may compute the probability that the state indicated by the generated unconfirmed fact is true as a score, and determine whether or not to include the unconfirmed fact in one or more initial facts using the computed score.

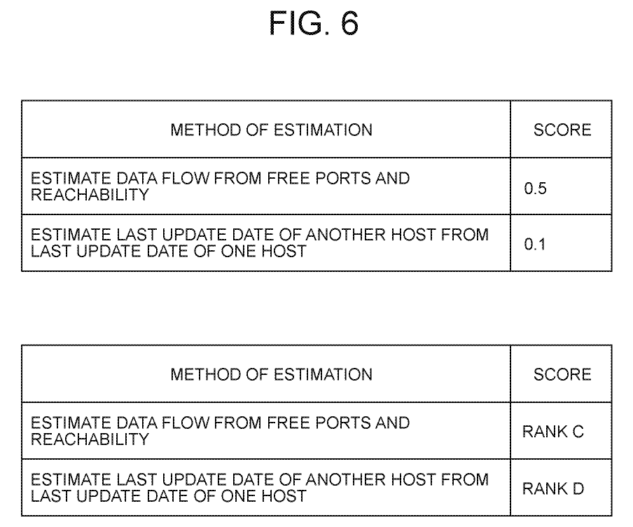

The score indicating the probability that the state indicated by the unconfirmed fact is true may be preset by the administrator. FIG. 6 is an explanatory diagram showing another example of a score indicating a probability that the state indicated by an unconfirmed fact is true.

As shown in the upper of FIG. 6, the administrator sets a predetermined score for each method of estimation in advance. For example, the probability of the existence of a data flow estimated from free ports and reachability is "0.5".

As shown in the lower of FIG. 6, the administrator may also set a score indicating the probability that the state indicated by the unconfirmed fact is true as a rank instead of a value. In the example shown in the lower of FIG. 6, the ranks are set as higher scores in the order of Rank C and Rank D.

As a third method of generating unconfirmed facts, the unconfirmed fact generation unit 104 may generate unconfirmed facts by statistically determining the possibility of including an unknown vulnerability based on the scan result.

For example, the unconfirmed fact generation unit 104 determines whether or not there is an unknown vulnerability from the following statistical information regarding the installed software known from the scan results, and if so, what kind of vulnerability it is. The types of vulnerabilities are, for example, arbitrary code execution, information leakage, and DoS (Denial of Service).

For example, the unconfirmed fact generation unit 104 statistically determines based on the software suite of installed software and the frequency of finding vulnerabilities of vendors. For example, the unconfirmed fact generation unit 104 computes the probability that the software includes a vulnerability based on the software suite or vendor of each software in the system to be diagnosed 200 by referring to statistical information regarding the frequency of finding vulnerability for each software suite or vendor.

The unconfirmed fact generation unit 104 also may compute the probability that the software includes a vulnerability based on the software suite and vendor of each software in the system to be diagnosed 200 by referring to statistical information regarding the frequency of finding vulnerability for each software suite and vendor.

Next, the unconfirmed fact generation unit 104 determines that a vulnerability exists in the software if the computed probability exceeds a predetermined threshold value. The reason for this is that software for which many vulnerabilities have been discovered in the past and software for which at least one of the software suite and vendor are the same is highly likely to have unknown vulnerabilities. In other words, the unconfirmed fact generation unit 104 generates unconfirmed facts based on the frequency of finding vulnerabilities for the software suite and vendor.

In addition, the unconfirmed fact generation unit 104 statistically determines based on the update frequency of the installed software. For example, the unconfirmed fact generation unit 104 determines that an unknown vulnerability exists in the software if the update frequency of the software exceeds a predetermined threshold value. The reason for this is that the more frequently the software is updated, the more likely it is that new vulnerabilities have been introduced. In other words, the unconfirmed fact generation unit 104 generates unconfirmed facts based on the update frequency for the software indicated by the configuration information.

Also, the unconfirmed fact generation unit 104 statistically determines based on software bug convergence curves (also referred to simply as bug curves) for installed software. Based on the number of bugs detected in the target software and the software bug convergence curve, the unconfirmed fact generation unit 104 determines whether or not an unknown vulnerability exists in the software. In other words, the unconfirmed fact generation unit 104 generates unconfirmed facts based on the bug curve for the software indicated by the configuration information.

Also, the unconfirmed fact generation unit 104 statistically determines based on the scale of the installed software. For example, the unconfirmed fact generation unit 104 computes the probability that the software includes a vulnerability based on the scale of each software in the system to be diagnosed 200 by referring to statistical information regarding the scale of the software and the presence or absence of the included vulnerabilities.

Next, the unconfirmed fact generation unit 104 determines that a vulnerability exists in the software if the computed probability exceeds a predetermined threshold value. The reason for this is that the larger the scale of the software, the more likely it is to include vulnerabilities. In other words, the unconfirmed fact generation unit 104 generates unconfirmed facts based on the scale related to the software.

If the installed software is OSS (Open Source Software), the unconfirmed fact generation unit 104 statistically determines based on the number of people in the OSS development community.

For example, the unconfirmed fact generation unit 104 computes the probability that the software includes a vulnerability based on the number of people in the development community of each software in the system to be diagnosed 200 by referring to the number of people in the development community of the software and statistical information regarding the presence or absence of included vulnerabilities.

Next, the unconfirmed fact generation unit 104 determines that a vulnerability exists in the software if the computed probability exceeds a predetermined threshold value. This is because the larger the number of people in the software's OSS development community, the higher the probability that sufficient debugging and maintenance has been performed.

Further, when the support of the installed software has ended, the unconfirmed fact generation unit 104 statistically determines based on the elapsed time from the end of the support. When support ends, the software is no longer managed by the vendor. The longer the elapsed time since the end of support, the higher the probability that vulnerabilities have been discovered in the software. Therefore, when the elapsed time exceeds the threshold value, the unconfirmed fact generation unit 104 determines that an unknown vulnerability exists in the software.

The unconfirmed fact generation unit 104 may also statistically determine the type of unknown vulnerability included in the software. For example, the unconfirmed fact generation unit 104 may use statistical information regarding the above-mentioned vulnerabilities, which is further aggregated for each type of vulnerabilities.

When the statistical information aggregated for each type of vulnerability is used, the unconfirmed fact generation unit 104 computes the probability that each software in the system to be diagnosed 200 includes a vulnerability for each type of vulnerability. Next, the unconfirmed fact generation unit 104 determines that a vulnerability related to the computed probability exists in the software when the computed probability exceeds a predetermined threshold value.

The fact generation information storage unit 105 stores statistical information and a predetermined threshold value as described above in advance. The statistical information includes the correspondence relationship between the statistical determination target and the unknown vulnerability. The unconfirmed fact generation unit 104 determines the existing unknown vulnerabilities by referring to the stored correspondence relationship.

The unconfirmed fact generation unit 104 may compute the probability that the state indicated by the generated unconfirmed fact is true as a score, and determine whether or not to include the unconfirmed fact in one or more initial facts using the computed score.

The unconfirmed fact generation unit 104 generates unconfirmed facts in the method described above. However, the method of generating unconfirmed facts by the unconfirmed fact generation unit 104 is not limited to the above method. For example, the unconfirmed fact generation unit 104 may generate unconfirmed facts by combining the above methods.

The unconfirmed fact generation unit 104 may also use a value N (N is an integer greater than or equal to 1) given separately by the administrator, and the like, for example. The unconfirmed fact generation unit 104 may compute the probability that each software includes a vulnerability based on the statistical information, and determine that the software having the highest computed probabilities from the first to the Nth includes a vulnerability.

Whether or not the conditions for generating unconfirmed facts as described above are satisfied depends on the system to be diagnosed 200, etc. If the conditions are not satisfied, the unconfirmed facts may not be generated.

The one or more initial facts stored in the initial fact storage unit 106 of this example embodiment may include unconfirmed facts generated by the unconfirmed fact generation unit 104. Further, the analysis unit 107 of this example embodiment analyzes the attack path assuming that unconfirmed facts also exist.

In other words, the analysis unit 107 determines whether or not the state indicated by one or more facts among a plurality of facts including a confirmed fact and an unconfirmed fact that satisfies a predetermined condition matches the conditions indicated by analysis rules, which are rules for deriving another fact. The predetermined condition is, for example, that the probability that the state indicated by the unconfirmed fact is true is greater than or equal to a predetermined threshold value.

By repeatedly executing the process of deriving another fact, the analysis unit 107 derives an attack that can be executed based on at least one of the confirmed fact and the unconfirmed fact and the analysis rule. Furthermore, based on the derived attack, at least one of the generated confirmed facts and the generated unconfirmed facts, and the analysis rules, the analysis unit 107 derives a new attack that can be executed.

In addition, the attack graph generated by the analysis unit 107 has information indicating whether each fact is a confirmed fact or an unconfirmed fact.

The visualization unit 109 has a function of displaying the generated attack graph indicated by the information stored in the analysis result storage unit 108 on a display means (not shown). The visualization unit 109 may not be provided in the analysis system 100.

The countermeasure planning unit 110 has a function of planning where and what countermeasures should be taken in the system to be diagnosed 200 in order to make the attack that cannot be executed based on the derived attack path. In other words, the countermeasure planning unit 110 plans countermeasures against attacks determined to be able to be executed by the analysis unit 107.

For example, the countermeasure planning unit 110 outputs countermeasures such as updating the OS of a predetermined host or adding a firewall to a predetermined network boundary. The countermeasure planning unit 110 may not be provided in the analysis system 100.

The extraction unit 111 has a function of extracting unconfirmed facts that contribute to the execution of the attack among the unconfirmed facts included in one or more initial facts. Specifically, the extraction unit 111 extracts unconfirmed facts among the confirmed facts and unconfirmed facts constituting the attack path indicated by the attack graph stored in the analysis result storage unit 108.

The extraction unit 111 presents the extracted unconfirmed facts. For example, the extraction unit 111 requests the administrator to confirm the extracted unconfirmed facts. If the contents of the unconfirmed facts are related to operations, the administrator may be able to determine the truth or falsehood of the unconfirmed facts.

The extraction unit 111 selects the unconfirmed facts to be additionally scanned from among the extracted unconfirmed facts, and instructs the scanner 101 to scan the selected unconfirmed facts. For example, the extraction unit 111 instructs the scanner 101 to scan by specifying a particularly important fact among the unconfirmed facts that contribute to the execution of the attack as the target of the additional scan.

As an important fact, for example, an unconfirmed fact for which the probability that the state indicated by the unconfirmed fact is true is above a certain first threshold value and below a second threshold value can be considered. Unconfirmed facts for which the probability that the state is true is sufficiently large are excluded from the target of the additional scan because the state is considered true even without additional scanning. Unconfirmed facts for which the probability that the state is true is sufficiently small are also excluded from target of the additional scan because the state is considered false even without additional scanning. The first threshold value and the second threshold value are values that are separately given by the administrator or the like.

Also, as an important fact, for example, unconfirmed facts whose success or failure of an attack changes depending on the presence or absence, i.e., unconfirmed facts related to the success or failure of an attack, or unconfirmed facts that affect more than a predetermined number of attack paths can be considered. For example, with regard to an unconfirmed fact that is the other condition of an OR condition where one condition is a confirmed fact, the extraction unit 111 does not have to specify it as an important fact because the OR condition is satisfied regardless of the presence or absence.

The OR condition means that each condition is a logical OR relationship in the attack path, i.e., the attack can be executed when at least one of the conditions is satisfied, and the attack cannot be executed when all of the conditions are not satisfied.

In addition, as an important fact, for example, unconfirmed facts that are predicted to be clarified as true or false by new information acquired through additional scans can be considered. The extraction unit 111 suppresses instructions for additional scans for facts that are impossible or significantly difficult to scan, such as unknown vulnerabilities.

In addition, the extraction unit 111 may determine whether or not the true or false of the unconfirmed fact can be clarified by the new information obtained in consideration of the characteristics of the scanner 101. If the scanner 101 is an agent installed in a host, which is a device included in the system to be diagnosed 200, the extraction unit 111 determines that the software settings, etc. installed on the host can be acquired.

In addition, if the scanner 101 is an appliance or the like that is connectable to a host that is a device included in the system to be diagnosed 200 through a communication network, the extraction unit 111 determines that it is difficult to acquire the software settings, etc. installed on the host.

Further, when multiple scanners are available, the extraction unit 111 may instruct the instruction unit 112 to output an instruction for additional scanning to the scanner that is most likely to be able to clarify the true or false of the unconfirmed facts by the new information obtained.

The instruction unit 112 inputs an instruction for scanning an unconfirmed fact selected by the extraction unit 111 to the scanner 101.

### Description of Operation

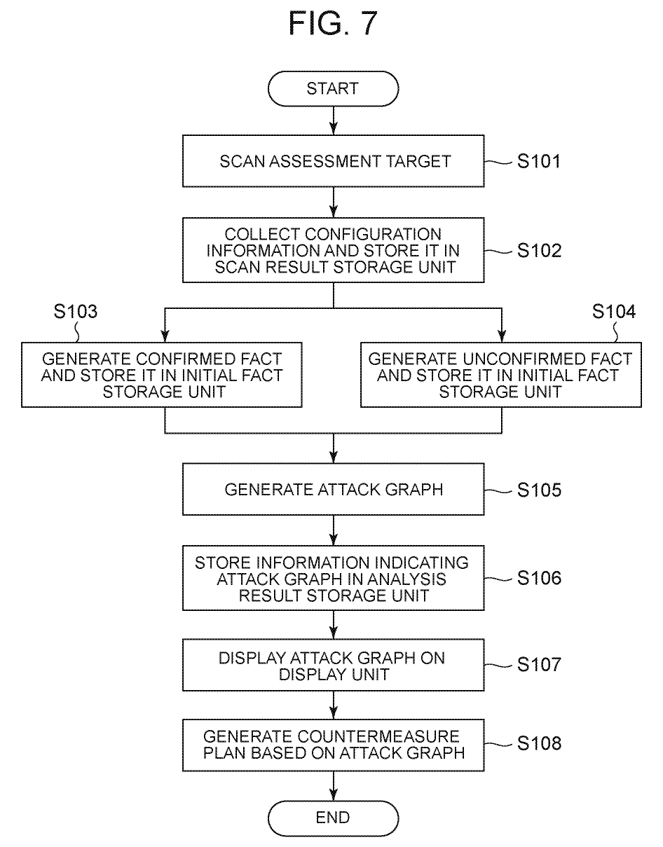

Hereinafter, the operation of generating the attack graph of the analysis system 100 of this example embodiment will be described with reference to FIG. 7. FIG. 7 is a flowchart showing the operation of the attack graph generation processing by the analysis system 100 of the first example embodiment.

First, the scanner 101 scans the system to be diagnosed 200 (step S101).

In step S101, the scanner 101 collects configuration information on the device included in the system to be diagnosed 200. Next, the scanner 101 stores the collected configuration information in the scan result storage unit 102 (step S102).

Next, the confirmed fact generation unit 103 generates confirmed facts by referring to the configuration information stored in the scan result storage unit 102. Next, the confirmed fact generation unit 103 stores the generated confirmed fact in the initial fact storage unit 106 (step S103).

The unconfirmed fact generation unit 104 generates unconfirmed facts. Next, the unconfirmed fact generation unit 104 stores the generated unconfirmed facts in the initial fact storage unit 106 (step S104).

When generating unconfirmed facts, the unconfirmed fact generation unit 104 may refer to the configuration information stored in the scan result storage unit 102 and the fact generation information stored in the fact generation information storage unit 105.

Next, the analysis unit 107 generates an attack graph by deriving an attack path of an attack that can be executed based on one or more initial facts stored in the initial fact storage unit 106 (step S105). Next, the analysis unit 107 stores information indicating the generated attack graph in the analysis result storage unit 108 (step S106).

Next, the visualization unit 109 displays the attack graph indicated by the information stored in the analysis result storage unit 108 on the display means (step S107).

Next, the countermeasure planning unit 110 generates a countermeasure plan including items that should be prioritized for countermeasures based on the derived attack path indicated by the information stored in the analysis result storage unit 108 (step S108).

After generating the countermeasure plan, the analysis system 100 ends the attack graph generation processing. Each processing of steps S107 and S108 may be omitted.

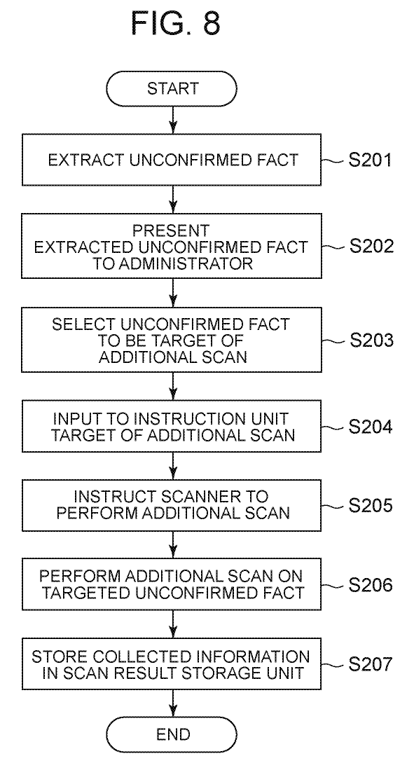

Next, the operation of performing an additional scan of the analysis system 100 of this example embodiment will be described with reference to FIG. 8. FIG. 8 is a flowchart showing the operation of the additional scan execution processing by the analysis system 100 of the first example embodiment.

First, the extraction unit 111 extracts unconfirmed facts among the facts constituting the attack path indicated by the attack graph stored in the analysis result storage unit 108 (step S201).

Next, the extraction unit 111 presents the extracted unconfirmed facts to the administrator (step S202). The processing of step S202 may be omitted.

Next, the extraction unit 111 selects the unconfirmed facts to be target of the additional scan among the extracted unconfirmed facts (step S203).

Next, the extraction unit 111 inputs to the instruction unit 112 that the selected unconfirmed fact is the target of an additional scan (step S204).

Next, the instruction unit 112 instructs the scanner 101 to perform the collection of information including unconfirmed facts on the inputted target (step S205).

Next, the scanner 101 collects information including unconfirmed facts about the target (step S206). The scanner 101 collects additional information and stores the collected information in the scan result storage unit 102 (step S207). After storing, the analysis system 100 ends the additional scan execution processing.

After the additional scan execution processing is end, the confirmed fact generation unit 103 may generate a confirmed fact again. After the confirmed fact is generated again, the analysis unit 107 may again derive an attack path.

### Description of Effect

With the above configuration, the analysis system 100 of this example embodiment can perform a comprehensive analysis that also targets unknown conditions. In other words, the analysis system 100 of this example embodiment can analyze a possibility of an attack in a system to be diagnosed 200 even when it is not possible to collect sufficient information from each device included in the system to be diagnosed 200.

In other words, the analysis system 100 of this example embodiment can analyze the possibility of attack in the system to be diagnosed 200 even when the device in the system to be diagnosed 200 cannot be scanned in detail, when all business traffic cannot be collected, when the available scanner products and scanning methods are limited, or when an unknown vulnerability is included, and the like.

### Variation

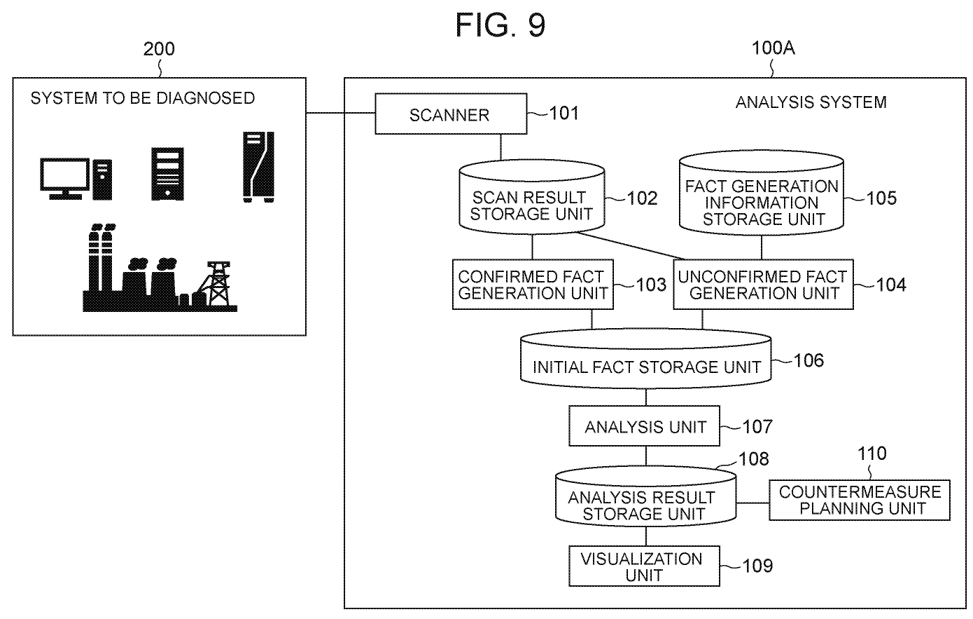

Hereinafter, a variation of this example embodiment is described. FIG. 9 is a block diagram showing another example of the configuration of the analysis system of the first example embodiment of the present invention.

The analysis system 100A shown in FIG. 9 includes the scanner 101, the scan result storage unit 102, the confirmed fact generation unit 103, the unconfirmed fact generation unit 104, the fact generation information storage unit 105, the initial fact storage unit 106, the analysis unit 107, the analysis result storage unit 108, the visualization unit 109, and the countermeasure planning unit 110. In other words, unlike the analysis system 100 shown in FIG. 1, the analysis system 100A does not include the extraction unit 111 and the instruction unit 112.

The analysis system 100A executes the attack graph generation processing shown in FIG. 7, but does not execute the additional scan execution processing shown in FIG. 8. In other words, the analysis system 100A performs from the execution of the scan to the analysis of the attack path.

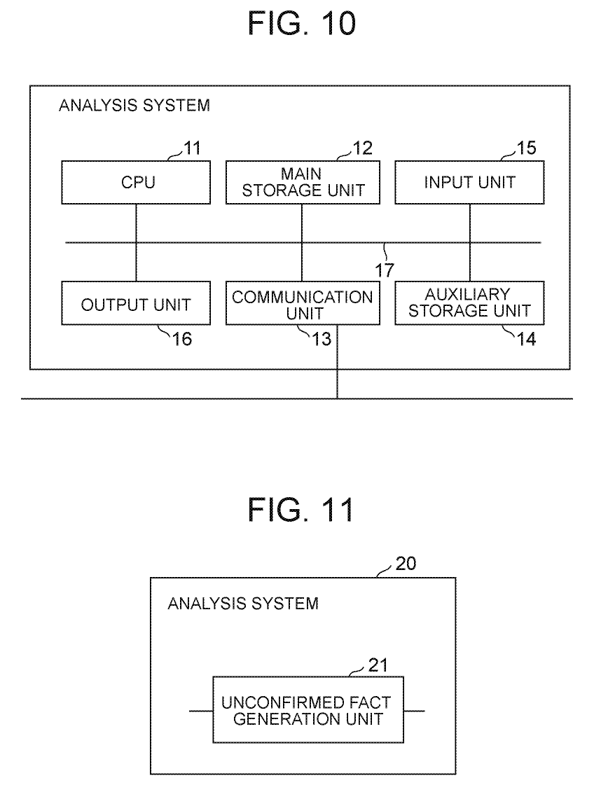

A specific example of a hardware configuration of the analysis system according to this example embodiment will be described below. FIG. 10 is an explanatory diagram showing an example of a hardware configuration of the analysis system according to the present invention.

The analysis system shown in FIG. 10 includes a CPU 11, a main storage unit 12, a communication unit 13, and an auxiliary storage unit 14. The analysis system also includes an input unit 15 for the user to operate and an output unit 16 for presenting a processing result or a progress of the processing contents to the user.

The analysis system is realized by software, as an example, by the CPU 11 shown in FIG. 10 executing a program that provides the functions possessed by each component.

Specifically, each function is realized by software as the CPU 11 loads the program stored in the auxiliary storage unit 14 into the main storage unit 12 and executes it to control the operation of the analysis system.

The main storage unit 12 is used as a work area for data and a temporary save area for data. The main storage unit 12 is, for example, RAM (Random Access Memory). The scan result storage unit 102, the fact generation information storage unit 105, the initial fact storage unit 106, and the analysis result storage unit 108 are realized by the main storage unit 12.

The communication unit 13 has a function of inputting and outputting data to and from peripheral devices through a wired network or a wireless network (information communication network). The scanner 101 may be realized by the communication unit 13.

The auxiliary storage unit 14 is a non-transitory tangible medium. Examples of non-transitory tangible media are, for example, a magnetic disk, an optical magnetic disk, a CD-ROM (Compact Disk Read Only Memory), a DVD-ROM (Digital Versatile Disk Read Only Memory), a semiconductor memory.

The input unit 15 has a function of inputting data and processing instructions. The input unit 15 is, for example, an input device such as a keyboard or a mouse.

The output unit 16 has a function of outputting data. The output unit 16 is, for example, a display device such as a liquid crystal display device.

As shown in FIG. 10, in the analysis system, each component is connected to the system bus 17.

The auxiliary storage unit 14 stores, for example, programs for realizing the scanner 101, the confirmed fact generation unit 103, the unconfirmed fact generation unit 104, the analysis unit 107, the visualization unit 109, the countermeasure planning unit 110, the extraction unit 111, and the instruction unit 112.

There are various variations of the realization method of the analysis system described above. For example, the analysis system may be realized by any combination of a separate information processing device and a program for each component. Also, a plurality of components comprised by the analysis system may be realized by any combination of a single information processing device and a program.

Some or all of the components may be realized by a general-purpose circuit (circuitry) or a dedicated circuit, a processor, or a combination of these. They may be configured by a single chip or by multiple chips connected via a bus. Some or all of the components may be realized by a combination of the above-mentioned circuit, etc. and a program.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

Next, an overview of the present invention will be explained. FIG. 11 is a block diagram showing an overview of an analysis system according to the present invention. The analysis system 20 according to the present invention includes an unconfirmed fact generation unit 21 (for example, the unconfirmed fact generation unit 104) which generates facts that indicate unknown information of a system to be diagnosed or a device among facts that indicate a state related to security in the system to be diagnosed or the device included in the system to be diagnosed, as unconfirmed facts.

With such a configuration, the analysis system can analyze a possibility of an attack in a system to be diagnosed even when it is not possible to collect sufficient information from each device in the system to be diagnosed.

While the present invention has been explained with reference to the example embodiments and examples, the present invention is not limited to the aforementioned example embodiments and examples. Various changes understandable to those skilled in the art within the scope of the present invention can be made to the structures and details of the present invention.

Some or all of the aforementioned example embodiment can be described as supplementary notes mentioned below, but are not limited to the following supplementary notes.

(Supplementary note 1) An analysis system comprising: an unconfirmed fact generation unit which generates facts that indicate unknown information of a system to be diagnosed or a device among facts that indicate a state related to security in the system to be diagnosed or the device included in the system to be diagnosed, as unconfirmed facts.

(Supplementary note 2) The analysis system according to Supplementary note 1, wherein the unconfirmed fact generation unit generates the unconfirmed facts based on configuration information of the device.

(Supplementary note 3) The analysis system according to Supplementary note 2, wherein the unconfirmed fact generation unit generates the unconfirmed facts based on an update frequency regarding software indicated by the configuration information, a bug curve regarding the software, or scale regarding the software.

(Supplementary note 4) The analysis system according to any one of Supplementary notes 1 to 3, further comprising: a confirmed fact generation unit which generates facts indicated by the configuration information among the facts as confirmed facts.

(Supplementary note 5) The analysis system according to Supplementary note 4, further comprising: an analysis unit which determines whether a state indicated by one or more facts among a plurality of facts which include the confirmed fact and the unconfirmed fact that satisfies a predetermined condition, matches conditions indicated by analysis rules which are rules for deriving another fact.

(Supplementary note 6) The analysis system according to Supplementary note 5, wherein the predetermined condition is that a probability that the state indicated by the unconfirmed facts is true is greater than or equal to a predetermined threshold value.

(Supplementary note 7) The analysis system according to Supplementary note 5 or 6, wherein the analysis unit derives an executable attack based on at least one of the confirmed facts and the unconfirmed facts and the analysis rules.

(Supplementary note 8) The analysis system according to Supplementary note 7, wherein the analysis unit derives a new executable attack based on the derived attack, at least one of the confirmed facts and the unconfirmed facts, and the analysis rules.

(Supplementary note 9) The analysis system according to Supplementary note 7 or 8, further comprising: a countermeasure planning unit which plans a countermeasure against the derived attack.

(Supplementary note 10) The analysis system according to any one of Supplementary notes 1 to 9, further comprising: a scanner which collects the configuration information from the device.

(Supplementary note 11) An analysis method comprising: generating facts that indicate unknown information of a system to be diagnosed or a device among facts that indicate a state related to security in the system to be diagnosed or the device included in the system to be diagnosed, as unconfirmed facts.

(Supplementary note 12) An analysis program causing a computer to execute: an unconfirmed fact generation process of generating facts that indicate unknown information of a system to be diagnosed or a device among facts that indicate a state related to security in the system to be diagnosed or the device included in the system to be diagnosed, as unconfirmed facts.

### Industrial Applicability

The present invention is suitably applied to an analysis system used in conjunction with an asset management system.

### Reference Signs List

11 CPU

12 Main storage unit

13 Communication unit

14 Auxiliary storage unit

15 Input unit

16 Output unit

17 System bus

20, 100, 100A Analysis system

21, 104 Unconfirmed fact generation unit

101 Scanner

102 Scan result storage unit

103 Confirmed fact generation unit

105 Fact generation information storage unit

106 Initial fact storage unit

107 Analysis unit

108 Analysis result storage unit

109 Visualization unit

110 Countermeasure planning unit

111 Extraction unit

112 Instruction unit

200 System to be diagnosed

1. An analysis system comprising:
a memory storing software instructions; and
one or more processors configured to execute the software instructions to:
when a first software is installed on a device included in a system to be diagnosed, generate an unconfirmed fact indicating unknown information that a second software is installed on the device, the second software being software that is installed by default on a device on which the first software is installed, wherein
the unconfirmed fact indicates a state related to security in the device.

2. The analysis system according to claim 1, wherein
the first software is an operating system, and the second software is software that is installed by default on a device on which the operating system is installed.

3. The analysis system according to claim 1, wherein the one or more processors are configured to execute the software instructions to further:
when installed software is open source software, generate an unconfirmed fact indicating that the open source software includes a vulnerability, based on a number of people in a development community of the open source software.

4. The analysis system according to claim 1, wherein the one or more processors are configured to execute the software instructions to further:
generate a new fact representing an attack executable in the system based on initial facts including at least one of the unconfirmed facts;
generate an attack graph represented by a graph in which the initial facts and the new fact are connected by lines; and
calculate feasibility of the attack using a probability that a state indicated by the unconfirmed fact is true.

5. The analysis system according to claim 4, wherein the one or more processors are configured to execute the software instructions to further:
extract an unconfirmed fact included in the attack graph;
select an unconfirmed fact to be scanned from the extracted unconfirmed fact;
exclude the selected unconfirmed fact from a target of scanning when a probability that a state indicated by the selected unconfirmed fact is true is smaller than a first threshold value; and
exclude the selected unconfirmed fact from the target of scanning when the probability that the state indicated by the selected unconfirmed fact is true is larger than a second threshold value.

6. The analysis system according to claim 4, wherein
the initial facts further include at least one of confirmed facts generated from information obtained from a scan.

7. The analysis system according to claim 1, wherein the one or more processors are configured to execute the software instructions to further:
calculate a probability that each software includes a vulnerability based on statistical information; and
generate, for each software whose calculated probability is ranked in the top N, an unconfirmed fact indicating that the software includes a vulnerability; wherein
N is an integer greater than or equal to 1 and is configurable by an administrator.

8. The analysis system according to claim 5, wherein the one or more processors are configured to execute the software instructions to further:
select, as the unconfirmed fact to be scanned, an unconfirmed fact that affects at least a predetermined number of attack paths in the attack graph.

9. An analysis method performed by a computer and comprising:
when a first software is installed on a device included in a system to be diagnosed, generating an unconfirmed fact indicating unknown information that a second software is installed on the device, the second software being software that is installed by default on a device on which the first software is installed, wherein
the unconfirmed fact indicates a state related to security in the device.

10. A non-transitory computer-readable recording medium storing an analysis program for causing a computer to execute processing comprising:
when a first software is installed on a device included in a system to be diagnosed, generating an unconfirmed fact indicating unknown information that a second software is installed on the device, the second software being software that is installed by default on a device on which the first software is installed, wherein
the unconfirmed fact indicates a state related to security in the device.
